(19) United States
(12) Patent Application Publication
(10) Pub. No.: US 2025/0322388 A1
(43) Pub. Date: Oct. 16, 2025

(54) METHOD AND SYSTEM FOR TRANSFERRING FUNDS BETWEEN A FINANCIAL INSTITUTION AND AN E-WALLET WITHIN AN INTERBANK NETWORK

(71) Applicants: Zhaoyu ZHU, Ottawa (CA); Yuan HUANG, Ottawa (CA); Haiqing PAN, Aurora (CA)

(72) Inventors: Zhaoyu ZHU, Ottawa (CA); Yuan HUANG, Ottawa (CA); Haiqing PAN, Aurora (CA)

(21) Appl. No.: 18/635,722

(22) Filed: Apr. 15, 2024

(51) Int. Cl. G06Q 20/36; G06Q 40/02

(52) U.S. Cl. CPC G06Q 20/3674; G06Q 40/02

(57) ABSTRACT

There is provided a method to transfer funds from a user's financial institution account to an electronic wallet (e-wallet). The e-wallet is provided by an e-wallet provider. The method includes obtaining a message addressed to an email address from an interbank network. The message includes the email address and a transaction identifier (ID). The method further includes obtaining an e-wallet ID associated with the e-wallet. The transaction ID is provided to the interbank network and a hash salt of a security question is obtained from the interbank network. The hash salt of the security question, the security answer and the e-wallet ID are provided to cause the interbank network to authenticate the transaction and the amount of funds is transferred from the account at the financial institution to the e-wallet provider and an e-wallet balance of the e-wallet is updated.

### CROSS-REFERENCE TO RELATED APPLICATIONS

This is the first application filed for the present invention.

### FIELD OF THE INVENTION

The present invention pertains to the field of electronic funds transaction, and in particular to methods and systems for transferring funds within an interbank network.

### BACKGROUND

Currently, interbank networks linking financial institutions and other enterprises are widely used for conducting financial transactions. For example, Interac™ is an interbank network in the Canadian debit card system which functions as a funds transfer network via its e-transfer service. The e-transfer service is provided by accessing the interbank network and accepting the debit payments.

However, existing e-transfer services (in particular, the Interac™ e-transfer service) include those based on a manual operation which requires matching a security question and a security answer within a banking application or portal. For example, a sender is required to login to their banking system to be able to send an e-transfer request and a recipient may be also required to login to their respective banking system to be able to accept the e-transfer funds (e.g., banking app, or banking web portal). Further, to accept the transfer, the recipient may be required to wait until receiving an email notification, which includes a link that connects the recipient to their banking system. Sometimes, there may be an undesired waiting period between when the e-transfer request is sent by the sender and the moment the associated email is received by the recipient.

Further, there is time delay between when the recipient receives the message (e.g., e-transfer transaction notification email) and the recipient manually enters the security answer to complete authentication of the transaction. The time delay may range from minutes to days.

Existing e-transfer services also offer automatic deposit of e-transferred funds, without requiring any question-and-answer steps. To set up the automatic deposit of e-transferred funds, the email address to which the funds are e-transferred must be linked to the bank account into which the funds are to be transferred.

However, at present, there is no effective and efficient way of transferring funds between a financial institution of a user to another financial institution of an e-wallet provider within an interbank network, to top-up an e-wallet of the user.

Therefore, there is a need for systems and methods that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

It is an object of the present disclosure to provide methods and systems for transferring funds from a user's financial institution account (bank account) to an electronic wallet (e-wallet) belonging to the same user (or, optionally, to a different user).

An aspect of the invention provides for a method to transfer an amount of funds from an account at a financial institution to an electronic wallet (e-wallet), from a perspective of an e-wallet provider. In embodiments, the account and the e-wallet belong to a same user. In embodiments, the e-wallet is provided by an e-wallet provider, and the e-wallet is associated with an email address. In embodiments, the financial institution and the e-wallet provider are coupled to an interbank network. The method further includes obtaining a message addressed to the email address from the interbank network. In embodiments, the message includes the email address and a transaction identifier (ID) identifying an electronic transfer (e-transfer) transaction request to transfer the amount of funds from the account at the financial institution to the e-wallet. The e-transfer transaction request is associated with a security question and a security answer to the security question, and the security question and the security answer to the security question are previously known by the e-wallet provider. The method further includes obtaining an e-wallet ID associated with the e-wallet, and providing the transaction ID to the interbank network. The method further includes obtaining a hash salt of the security question from the interbank network, in response to the interbank network having received the transaction ID. The method further includes providing the hash salt of the security question, the security answer and the e-wallet ID to the interbank network to cause the interbank network to authenticate the transaction and to transfer the amount of funds from the account at the financial institution to the e-wallet provider. The method further includes updating an e-wallet balance of the e-wallet, in accordance with the e-wallet account ID and in accordance with the amount of funds.

Another aspect of the invention provides for a method to transfer an amount of funds from an account at a financial institution to an electronic wallet (e-wallet), from a perspective of an interbank network. In embodiments, the account and the e-wallet belong to a same user. In embodiments, the e-wallet is provided by an e-wallet provider, and the e-wallet is associated with an email address. In embodiments, the financial institution and the e-wallet provider are coupled to an interbank network. The method includes receiving an electronic transfer (e-transfer) transaction request from the financial institution. The transaction request includes the amount of funds to be transferred, an email address associated with the e-wallet, a security question, and a security answer to the security question. In embodiments, the security question and the security answer to the security question are previously known by the e-wallet provider. The method further includes generating a transaction identifier (ID) for the e-transfer request and sending a message to the email address associated with the e-wallet. The message includes the transaction ID and the email address. When the message is received at the e-wallet provider, the e-wallet provider is caused to obtain an e-wallet ID associated with the e-wallet, in accordance with the email address. The method further includes receiving the transaction ID from the e-wallet provider, and providing a hash salt of the security question to the e-wallet provider, in accordance with the transaction ID. The method further includes obtaining the hash salt of the security question, the security answer and the e-wallet ID from the e-wallet provider to cause the interbank network to authenticate the transaction and to transfer the amount of funds from the account at the financial institution to the e-wallet provider. The method further includes updating an e-wallet balance of the e-wallet, in accordance with the e-wallet account ID and in accordance with the amount of funds.

Another aspect of the invention provides for a method to transfer an amount of funds from an account at a financial institution to an electronic wallet (e-wallet), from a perspective of an e-wallet provider. In embodiments, the account and the e-wallet belong to a same user. In embodiments, the e-wallet is provided by an e-wallet provider, and the e-wallet is associated with an email address. In embodiments, the financial institution and the e-wallet provider are coupled to an interbank network. The method includes obtaining a message containing a transaction identifier (ID) identifying an electronic transfer (e-transfer) transaction request initiated to transfer the amount of funds from the account at the financial institution to the e-wallet. In embodiments, the message also includes a security question associated with the e-transfer request. The e-transfer transaction request also is associated with a security response to the security question. The method further includes obtaining an e-wallet ID identifying the e-wallet, in accordance with the security question, and providing the transaction ID to the interbank network. The method further includes obtaining a hash salt of the security question from the interbank network, in response to the interbank network having received the transaction ID. The method further includes providing the hash salt of the security question, the security answer and the e-wallet ID to the interbank network to cause the interbank network to authenticate the transaction and to transfer the amount of funds from the account at the financial institution to the e-wallet provider. The method further includes updating an e-wallet balance of the e-wallet, in accordance with the e-wallet ID and in accordance with the amount of funds.

Another aspect of the invention provides for a method to transfer an amount of funds from an account at a financial institution account to an electronic wallet (e-wallet), from a perspective of an e-wallet provider. In embodiments, the account and the e-wallet belong to a same user. In embodiments, the e-wallet is provided by an e-wallet provider. In embodiments, the financial institution and the e-wallet provider are coupled to an interbank network. The method includes obtaining a message containing a name of an individual transferring the amount funds from the account at the financial institution account to the e-wallet. In embodiments, the message also includes a transaction identifier (ID) identifying an electronic transfer (e-transfer) transaction request to transfer the amount of funds from the account at the financial institution to the e-wallet. The e-transfer transaction request is associated with a security question and a security answer to the security question, the security question and the security answer to the security question are known to the e-wallet provider. The method further includes obtaining an e-wallet account ID associated with the e-wallet account, in accordance with the name of the individual. The method further includes providing the transaction ID to the interbank network, and obtaining a hash salt of the security question from the interbank network, in response to the interbank network having received the transaction ID. The method further includes providing the hash salt of the security question, the security answer and the e-wallet ID to the interbank network to cause the interbank network to authenticate the transaction and to transfer the amount of funds from the account at the financial institution to the e-wallet provider. The method further includes updating an e-wallet balance of the e-wallet, in accordance with the e-wallet ID and in accordance with the amount of funds.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows a flowchart of an embodiment of a method to transfer funds from a financial institution account to an electronic wallet (e-wallet), according to the present disclosure.

FIG. 2 shows a flowchart of another embodiment of a method to transfer funds from a financial institution account to an e-wallet, according to the present disclosure.

FIG. 3 shows a flowchart of a further embodiment of a method to transfer funds from a financial institution account to an e-wallet, according to the present disclosure.

FIG. 4 shows an embodiment of a system in accordance with the present disclosure.

FIG. 5 shows an embodiment of a process flow in accordance with the present disclosure.

It will be noted that throughout the appended drawings, like features may be identified by like reference numerals.

### DETAILED DESCRIPTION

Embodiments of the present disclosure provide methods and systems for transferring funds from a user's financial institution account (bank account) to an electronic wallet (e-wallet) belonging to the same user (or, optionally, to a different user). The financial institution account is associated with a financial institution, and the e-wallet is associated with an e-wallet provider that has multiple e-wallets, each e-wallet associated to an e-wallet subscriber (i.e., a user). The funds are transferred to an account belonging to the e-wallet provider (e-wallet provider account) and the e-wallet provider updates the balance of the user's e-wallet to reflect the transferred funds. In relation to the present disclosure, the financial institution and the e-wallet provider are part of an interbank network. The e-wallet provider manages multiple e-wallets and each e-wallet is associated with an e-wallet subscriber (i.e., a user). Generally, each e-wallet subscriber (i.e., a user) will have only one e-wallet and the e-wallet may be associated with one or more financial institution accounts of the user. In some embodiments, the financial institution account(s) and the e-wallet may belong to the same person. In other embodiments, the financial institution accounts(s) and the e-wallet may belong to different persons. Embodiments of the present disclosure allow a person to transfer funds from their financial institution account to the e-wallet provider account and for the e-wallet provider to update the balance of the e-wallet according to the transferred funds.

Unless defined otherwise, all technical and scientific terms used herein have the same meaning as commonly understood by one of ordinary skill in the art to which this invention belongs.

The following embodiments are intended to describe certain aspects of the invention but are not intended to limit the scope of the invention in any way.

In some embodiments, an individual will open an e-wallet account by registering with the e-wallet provider. Any suitable registering process may be used. As describe below, an embodiment of the registration process may include the individual (the person, the user) accessing a mobile application, or a web portal associated with the e-wallet provider, providing a login email address (e.g., a personal email address such as a Hotmail or a Gmail email address, a professional or an organizational email address) and providing a login password. In embodiments, additional information such as, for example, the name, phone number, etc. of the individual may be obtained to assist in identifying the individual (the user, the e-wallet subscriber). Subsequently, the e-wallet provider opens an e-wallet (an e-wallet account), generates an e-wallet account ID and another email address associated with the e-wallet account and assigns the e-wallet account ID and the other email address to the user (to the user account). The e-wallet provider also generates and assigns a security question and an answer to the security question to the e-wallet. In embodiments, the other email address is unique, ends with a domain name associated with the e-wallet provider and may be a virtual email address. In embodiments, the unique e-wallet account ID, the unique virtual email address, the security question and the answer to the security question are automatically generated by the e-wallet provider and cannot be modified by the e-wallet subscriber (i.e., the user).

In some embodiments, a data store may be part of or may be coupled to the e-wallet provider and the data store may be configured to store each the user's information (e.g., email address(es), security profile, names, security question and answer, etc.) associated with their e-wallet account and e-wallet account ID. The data store may be any suitable repository for storing and managing data. Non-limiting examples of a data store include a file, a file system and a database.

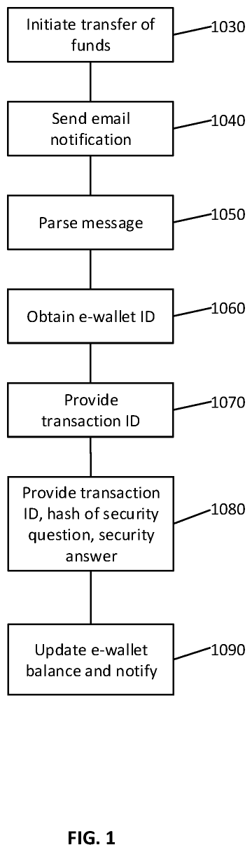

FIG. 1 shows a flowchart of an embodiment of a method to transfer funds from a financial institution account to an e-wallet, according to the present disclosure. The financial institution account and the e-wallet may belong to the same individual. The e-wallet is associated with an e-wallet provider and the e-wallet provider has associated thereto an e-wallet provider account. The actions shown in FIG. 1 take place after the user has registered an e-wallet account with the e-wallet provider and the virtual email address has been assigned to the e-wallet.

At action 1030, the user, when logged into their financial institution account (e.g., a bank account) through any suitable interface (e.g., a mobile application, a web portal, etc.), initiates an e-transfer of funds from the financial institution account to the virtual email address associated to the user's e-wallet. The user may select the financial institution account from which the funds are to be transferred. The funds are to transfer through the interbank network to which both the e-wallet provider and the financial institution are coupled (connected). The transfer of funds from the user's financial institution account to the user's virtual email address (which is associated with the user's e-wallet) may be referred to as a top-up (top-up operation) of the user's e-wallet.

In the present embodiment, initiating the transfer of funds from the user's financial institution account to the user's e-wallet includes the user providing to their financial institution, through the mobile application, or web portal, the email address to which an email notification of the e-transfer is to be sent. In this case, the email address is the virtual email address associated with the e-wallet. Initiating the e-transfer of funds according to this embodiment also includes the user providing to their financial institution, in the context of the e-transfer of funds, the identical security question and security answer provided to the user, by the e-wallet provider, at the time the user setup their e-wallet.

After the interbank network receives the request for the e-transfer of funds, the interbank network sends, at action 1040, an email notification (e.g., an email message) to the email address contained in the e-transfer request; that is, the interbank network sends the email notification to the aforementioned virtual email address. The email notification may include information such as the legal name of the user (sender), a recipient's email address (the user's virtual email address), the amount of funds to be transferred, and a link to accept the funds e-transfer. The email notification may also contain a transaction identifier (ID) (transaction reference number provided by the financial institution) that identifies the e-transfer transaction and the security question. In some embodiments, the email notification, on its face, does not show the transaction ID, or security question/answer. Rather, the transaction ID may be “embedded” in the message.

The e-wallet provider may receive the email notification through any suitable email server configured to receive email messages that have a predetermined domain (domain name or IP address), regardless of the local-part of the email address. That is, the email server may be configured to receive email notifications sent to virtual email addresses that have the predetermined domain. The email server may also be configured to forward all emails having the same domain to a forwarding email address. In the present embodiment, the forwarding email address is associated with the e-wallet provider.

At action 1050, the e-wallet provider having received the email notification may perform parsing operations on the email notification to obtain the transaction ID (the transaction reference number, e.g., the Interac™ reference number), the recipient's email address (e.g., the user's virtual email address) as well as the sender's name.

At action 1060, the e-wallet provider obtains, e.g., from a data store associated with the e-wallet provider, the e-wallet ID associated with the virtual email address extracted at action 1050.

At action 1070, the e-wallet provider provides, to the interbank network, the transaction ID obtained from the parsing at action 1050. In return, the interbank network provides, to the e-wallet provider, the amount of the transfer, the security question, and a hash salt of the security question associated with the transaction ID (i.e., associated with the virtual email address).

At action 1080, the e-wallet provider provides, to the interbank network, the transaction ID, the hash salt of the security question and the security answer to the interbank network for the interbank network to authenticate the funds transfer request and to transfer the funds to the e-wallet provider account.

At action 1090, e-wallet balance is updated to reflect the transfer of funds and the user is notified through, for example, an e-wallet application on the user's mobile device.

Furthermore, the e-wallet provider is coupled to a data store that stores a plurality of virtual email addresses. Each virtual email address is associated with a respective e-wallet ID and with the e-wallet owner's email address used to register with the e-wallet provider. In embodiments, the e-wallet provider is configured to parse the message to extract the virtual email address and obtaining the e-wallet ID associated with the virtual email address from the data store.

In embodiments, the action of providing the transaction ID to the interbank network is preceded by the action of parsing the message to extract the transaction ID.

In embodiments, obtaining the message from the interbank network includes obtaining the message from the interbank network through an email server.

In embodiments, the action of authenticating the transaction in the interbank network can be bypassed by setting an auto-deposit mechanism (e.g., the unique virtual email address of the recipient/user added as an auto-deposit email address). In this approach, the user is no longer required to enter a security question and a corresponding security answer when sending the e-transfer request at action 1030. As a result, when auto-deposit is enabled, the sender/user sends a transaction request to the interbank network, and the interbank network is caused to transfer the funds from the financial institution account of the sender (i.e., the sender is the user) to the financial institution account of the e-wallet provider (in other words, actions 1040, 1050, 1060, 1070 of FIG. 1 can be bypassed).

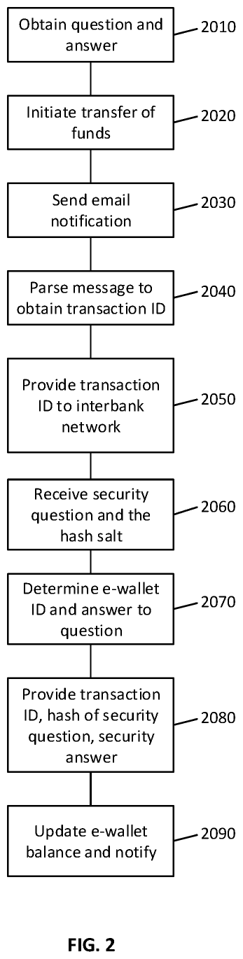

FIG. 2 shows a flowchart of another embodiment of a method to transfer funds from an account at financial institution account to an e-wallet, according to the present disclosure. Notably, the embodiment of FIG. 2 does not include the e-wallet provider assigning a unique virtual email address to each e-wallet.

As in other embodiments, a user registers with the e-wallet provider to open an e-wallet. Any suitable registering process may be used. The registration process may include the individual (the person, the user) accessing a mobile application, or a web portal associated with the e-wallet provider, providing a login email address and providing a login password. Subsequently, the e-wallet provider opens an e-wallet and generates an e-wallet account ID. In embodiments, the e-wallet ID is automatically generated by the e-wallet provider and cannot be modified.

At action 2010, a user wanting to top-up their e-wallet obtains a security question and an answer to the question from their e-wallet provider. Obtaining the question/answer may be done by the user connecting to their e-wallet (to the e-wallet provider) through a mobile application or a web portal and requesting a question/answer. The question/answer provided by the e-wallet provider may be unique and serve to identify the user. At action 2020, the user, when logged into their financial institution account (e.g., a bank account) through any suitable interface (e.g., a mobile application, a web portal, etc.), initiates an e-transfer of funds from the account at the financial institution to an email address associated with the user's e-wallet. The user may select the financial institution account from which the funds are to be transferred. The funds are to transfer through the interbank network to which both the e-wallet provider and the financial institution are coupled (connected). The transfer of funds from the account at the financial institution account to the user's e-wallet may be referred to as a top-up (top-up operation) of the user's e-wallet.

In the present embodiment, initiating the transfer of funds from the user's financial institution account to the user's e-wallet includes the user providing to their financial institution, through a mobile application, or a web portal, an email address to which an email notification of the e-transfer is to be sent. In this case, the email address is not a virtual email address associated with the e-wallet. Rather, the email address to which an email notification of the e-transfer is to be sent is a real email address of the e-wallet provider (real email address associated to the e-wallet provider). This real email address may be the email address to which all e-transfer email notifications from all the users subscribed to the e-wallet provider are sent. Initiating the e-transfer of funds according to this embodiment may also include the user providing to their financial institution, in the context of the e-transfer of funds, the identical security question and security answer provided to the user, by the e-wallet provider, at action 2010. In embodiments, the security question serves as a unique identifier so that the e-wallet provider can determine which user initiated the top-up transaction. The unique identifiers may be of any suitable type. In some embodiments, the unique identifiers may include unique strings of numbers and/or characters.

The interbank network sends, at action 2030, an email notification (e.g., an email message) to the email address contained in the e-transfer request (e.g., the email address of the e-wallet provider). The email message may include, for example, an e-transfer transaction request identifier, the amount of funds to be transferred, the name of the sender, and a link to accept the e-transfer. At action 2040, the e-wallet provider performs parsing of the email notification to extract the transaction ID associated with the transaction.

The e-wallet provider may receive the email notification through any suitable email server configured to receive email messages that have the predetermined e-wallet provider email address such as, for example, an email address defined by a unique domain (domain name or IP address) and a unique specific local-part.

At action 2050, the e-wallet provider provides, to the interbank network, the transaction ID obtained from parsing at action 2040 and in return, the e-wallet provider obtains, at action 2060, a hash salt of the security question, the security question, and the amount sent.

Based on the security question, the e-wallet provider determines, at action 2070, an e-wallet ID associated with the e-wallet.

Notably, each e-transfer request must include a security question to allow action 2070 to obtain the e-wallet account ID as well as the answer to the security question.

At action 2080, the e-wallet provider provides the transaction ID (interbank network reference number), the hash salt of the security question, and the answer to the security question to the interbank network to cause the interbank network to authenticate the transaction. At action 2090, the funds are transferred from the user's financial institution account to the e-wallet provider's financial institution account, and the balance of the user's e-wallet is updated to reflect the transfer of funds and the user is notified through, for example, an e-wallet application on the user's mobile device.

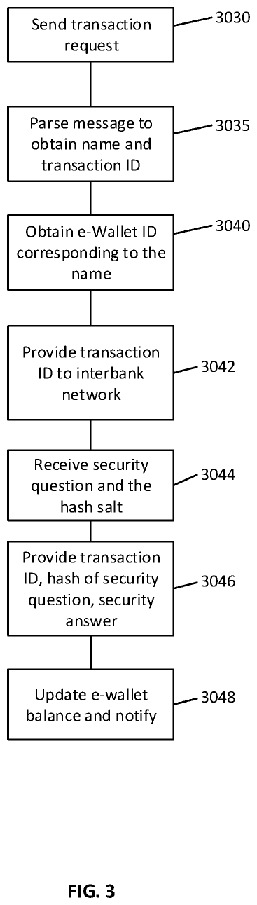

FIG. 3 shows a flowchart of another embodiment of a method to transfer funds from an account at financial institution account to an e-wallet, according to the present disclosure.

As in embodiments described elsewhere in the present disclosure, any suitable process to set up (register) an e-wallet with an e-wallet provider may be used. The registration process may include the individual (the person, the user) accessing a mobile application, or a web portal associated with the e-wallet provider, providing a login email address (e.g., a personal email address such as Hotmail or Gmail, a professional or organizational email) and providing a login password. Subsequently, the e-wallet provider opens an e-wallet and generates an e-wallet account ID. In embodiments e-wallet account ID is automatically generated by the e-wallet provider and cannot be modified. Subsequently, the user enters their legal name or full name in the e-wallet account. In embodiments, upon entry, the user's legal name or full name can no longer be modified.

At action 3030, the user logins into their financial institution account (e.g., a bank account) and initiates a transaction (e.g., an e-transfer request), via the interbank network (e.g., the Interac™ system), to an email address associated with a mail server coupled to the e-wallet provider. In this case, the email address is an auto-deposit email address in the interbank network. It is managed by the e-wallet provider and associated with all the e-wallet accounts.

In practice, upon receiving the transaction request, the interbank network (e.g., Interac system) sends an email notification (an email) to the auto-deposit email address associated with the e-wallet provider. The email notification includes the same name (legal name or full name) as the one provided when the user setup their e-wallet. That is, the email notification includes the name of an individual transferring the funds from the financial institution account to their e-wallet. The email notification also includes the e-transfer transaction request ID identifying the e-transfer transaction request to transfer funds from the account at the financial institution to the e-wallet.

At action 3035, the e-wallet provider parses the email notification to obtain the name of the individual transferring the funds and the transaction number (Interac reference number). At action 3040, the e-wallet provider identifies the e-wallet that matches the name (obtains the e-wallet ID). At action 3042, the e-wallet provider provides the transaction ID to the interbank network and, in return, at action 3044, receives a hash salt of the security question, the amount transferred, and the security question.

At action 3046, the e-wallet provider provides the hash of the security question, the security answer and the transaction ID to the interbank network to cause the interbank network to transfer the funds from the account at the financial institution to the e-wallet provider which manages the e-wallet associated with the e-wallet account ID. Notably, the e-wallet provider manages the e-wallets of all the users.

At action 3048, the e-wallet provider updates the user's e-wallet balance (e.g., the sender's e-wallet balance and/or the recipient's e-wallet balance), and sends a notification to the user, which marks the end of the transaction.

Referring to FIG. 3, the drawback is that when two or more users have the same full names/legal names, the e-wallet provider is unable to retrieve a corresponding e-wallet account ID based on a user's full name/legal name.

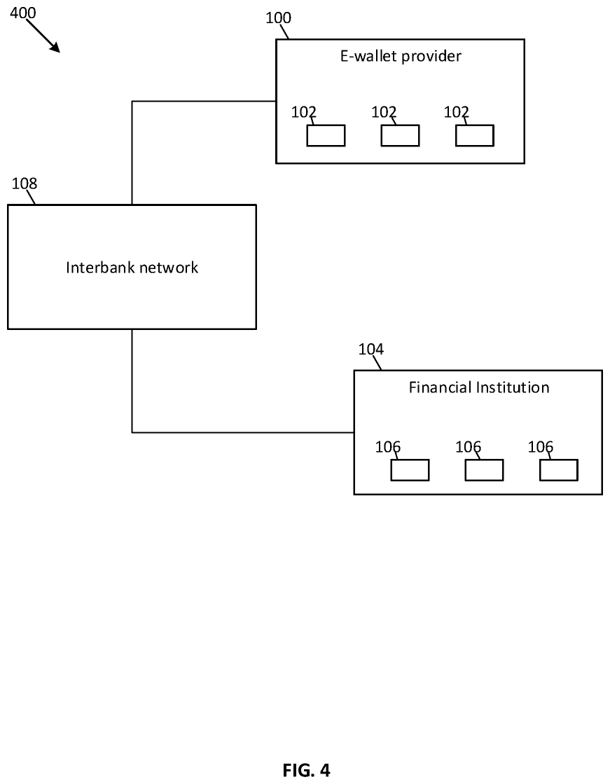

FIG. 4 shows a block diagram of an embodiment of a system 400 in accordance with the present disclosure. The system 400 comprises an e-wallet provider 100, which includes multiple e-wallet accounts 102. The system 400 further comprises an interbank network 108 connected to the e-wallet provider. Furthermore, the system 400 comprises a financial institution 104, which includes multiple financial institution accounts 106. The financial institution is connected to the interbank network 108. The methods described above in relation to the embodiments shown at FIGS. 1-3, may be implemented in the system 400.

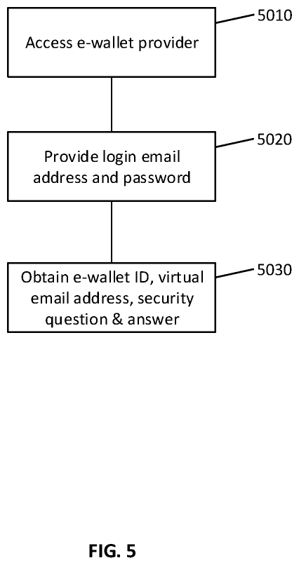

FIG. 5 shows a flowchart an embodiment of a method in accordance with present disclosure. The process flow illustrates an individual (a person, or a user) opening an e-wallet account by registering with the e-wallet provider. At action 5010, the user accesses the e-wallet provider, for example, via a mobile application or a web portal associated with the e-wallet provider. At action 5020, the user provides a login email address and a login password for setting up the e-wallet account. At action 5030, the user obtains an e-wallet ID, another email address associated with the e-wallet account, a security question and an answer to the security question, from the e-wallet provider. In embodiments, the other email address is unique, ends with a domain name associated with the e-wallet provider and may be a virtual email address. In embodiments, the unique e-wallet account ID, the unique virtual email address, the security question and the answer to the security question are automatically generated by the e-wallet provider and cannot be modified by the e-wallet subscriber (i.e., the user).

In embodiments, the recipient's acceptance of e-transfer funds is deemed automatic without any action required from the recipient.

Furthermore, the aforementioned methods may be performed with respect to a multi-tier user system. Notably, users may be classified into multiple levels (the number of levels can easily change based on needs), depending on types of transactions, transaction amounts, number of transactions, the maximum e-wallet balance amount, and user identity verification steps undertaken. The depth of the identification verification may depend on the e-wallet level the user wants to have, the transaction amounts needed/desired by the user, the types of transactions the user wants to perform, the maximum amount the user wants to store in its e-wallet, or the number of transactions performed or to be performed by the users. Each e-wallet level has their own privileges and limitations. For example, a five-level or a five-tier user system may be such that a user's identity is fully verified at level 5 (i.e., user is compliant with FINTRAC user identity verification requirements).

In practice, new users can register by providing minimal personal information and immediately start using and benefiting from the platform or system. Unlike traditional e-wallet applications, the users do not have to immediately provide all of their personal information and go through an ID document verification process, which can be time-consuming.

In embodiments, the user may withdraw money from their e-wallet (no more than the current e-wallet account balance) by transferring the money, through an electronic fund transfer (EFT) into the user's financial institution account (e.g., a bank account linked to the e-wallet account).

In embodiments, a first user may transfer funds in an amount no more than the current e-wallet balance from the user's own e-wallet account to a second user's e-wallet account. The user-to-user transfer (also referred to as peer-to-peer transaction or P2P transaction) does not involve the sender accessing his or her financial institution account or sending an e-transfer transaction request from the financial institution account. Instead, the e-wallet provider receives such a request and updates the e-wallet account balances in the respective user accounts. In practice, the e-transfer funds are not transferred in or out of the financial institution account of the e-wallet provider for funds transfer between users.

Notably, in-store shopping or online shopping can be enabled by payment clearing and settlement between a consumer (i.e., the first user) and a merchant (the second user). For example, the consumer may use a mobile device (e.g., smart phone, tablet, etc.) to scan a QR code displayed in-store or on a webpage linked to the merchant's e-wallet account and be directed to send an e-transfer request. Similar to the peer-to-peer transaction or P2P transaction described above, the e-transfer between consumer and merchant also includes an internal update of e-wallet balances of each user (i.e., the consumer and the merchant) to reflect the purchase and the flow of funds. In other embodiments, when a user is ready to pay, they would go to their e-wallet app and switch to a “pay and receive” mode where a QR code is displayed. The merchant would use their point-of-sale (POS) scanner to scan the user's QR code and subsequently receive payment.

In the case of an e-commerce payment, a unique QR code containing the order information would be displayed to the user after they check out their order. The user would then go to the e-wallet app, switch to the “pay and receive” tab, and find the e-wallet app's QR code scanner to complete the payment.

Upon completing such a transfer between users, the merchant's financial institution account balance is updated to indicate an increase of the payment amount, and the customer's e-wallet account balance is updated to indicate a deduction of payment amount. In practice, there can be a lapse of time between the merchant's financial institution account balance update and when the payment is actually been paid to the merchant's financial institution account. In practice, the e-wallet provider receives the e-transfer request and updates the e-wallet account balance of the user/consumer instantly, and transfer funds out of the e-wallet provider's financial institution account and into the merchant's financial institution account (instantly or at a later time as agreed between the merchant and the e-wallet provider). The payment can be settled by sending an EFT from the e-wallet provider's financial institution account to the merchant's financial institution account to ensure the merchant being paid in a timely manner. For example, the payments/funds owed to the merchant can be cleared and settled on a daily basis. Furthermore, the e-wallet provider calculates the net amount owed to the merchant after deducting any fees or charges if applicable and may also manually review and approve the settlement of funds before the funds are transferred to the merchant. Notably, the merchant is not required to have an e-wallet.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method to transfer an amount of funds from an account at a financial institution to an electronic wallet (e-wallet), the account and the e-wallet belonging to a same user, the e-wallet being provided by an e-wallet provider, the e-wallet having associated thereto an email address, the financial institution and the e-wallet provider being coupled to an interbank network, the method comprising:
at the e-wallet provider:
obtaining, from the interbank network, a message addressed to the email address, the message comprising the email address and a transaction identifier (ID) identifying an electronic transfer (e-transfer) transaction request to transfer the amount of funds from the account at the financial institution to the e-wallet, the e-transfer transaction request having associated thereto a security question and a security answer to the security question, the security question and the security answer to the security question being previously known by the e-wallet provider;
in accordance with the email address, obtaining an e-wallet ID associated with the e-wallet;
providing, to the interbank network, the transaction ID;
in response to the interbank network having received the transaction ID, obtaining, from the interbank network, a hash salt of the security question;
providing, to the interbank network, the hash salt of the security question, the security answer and the e-wallet ID to cause the interbank network to authenticate the transaction and to transfer the amount of funds from the account at the financial institution to the e-wallet provider; and
in accordance with the e-wallet account ID and in accordance with the amount of funds, updating an e-wallet balance of the e-wallet.

2. The method of claim 1, wherein:
the email address is a virtual email address; and
obtaining the message includes receiving the message addressed to the virtual email address at a real email address of the e-wallet provider.

3. The method of claim 1, wherein the e-wallet provider is coupled to a data store having stored thereat a plurality of email addresses each associated with a respective e-wallet ID, the method further comprising, at the e-wallet provider:
parsing the message to extract therefrom the email address; and
obtaining, from the data store, the e-wallet ID associated with the e-mail address.

4. The method of claim 1, wherein providing, to the interbank network, the transaction ID is preceded by parsing the message to extract therefrom the transaction ID.

5. The method of claim 1, wherein obtaining the message from the interbank network includes obtaining the message from the interbank network through an email server.

6. A method to transfer an amount of funds from an account at a financial institution to an electronic wallet (e-wallet), the account and the e-wallet belonging to a same user, the e-wallet being provided by an e-wallet provider, the e-wallet having associated thereto an email address, the financial institution and the e-wallet provider being coupled to an interbank network, the method comprising:
at the interbank network:
receiving, from the financial institution, an electronic transfer (e-transfer) transaction request comprising the amount of funds to be transferred, an email address associated with the e-wallet, a security question, and a security answer to the security question, the security question and the security answer to the security question being previously known by the e-wallet provider;
generating a transaction identifier (ID) for the e-transfer request;
sending a message to the email address associated with the e-wallet, the message comprising the transaction ID and the email address which, when the message is received at the e-wallet provider, is to cause the e-wallet provider to obtain, in accordance with the email address, an e-wallet ID associated with the e-wallet;
receiving, from the e-wallet provider, the transaction ID;
in accordance with the transaction ID, providing, to the e-wallet provider, a hash salt of the security question; and
obtaining, from the e-wallet provider, the hash salt of the security question, the security answer and the e-wallet ID to cause the interbank network to authenticate the transaction and to transfer the amount of funds from the account at the financial institution to the e-wallet provider to cause the e-wallet provider to update an e-wallet balance of the e-wallet, in accordance with the e-wallet account ID and in accordance with the amount of funds.

7. The method of claim 6, wherein:
the email address is a virtual email address; and
sending the message includes sending the message addressed to the virtual email address to a real email address of the e-wallet provider.

8. The method of claim 6, wherein the e-wallet provider is coupled to a data store having stored thereat a plurality of email addresses each associated with a respective e-wallet ID, the method further comprising, at the e-wallet provider:
parsing the message to extract therefrom the email address; and
obtaining, from the data store, the e-wallet ID associated with the e-mail address.

9. The method of claim 6, wherein receiving, from the e-wallet provider, the transaction ID is preceded by, at the e-wallet provider, parsing the message to extract therefrom the transaction ID.

10. The method of claim 6, wherein sending the message includes sending the message through an email server.

11. A method to transfer an amount of funds from an account at a financial institution to an electronic wallet (e-wallet), the account and the e-wallet belonging to a same user, the e-wallet being provided by an e-wallet provider, the e-wallet having associated thereto an email address, the financial institution and the e-wallet provider being coupled to an interbank network, the method comprising:
at the e-wallet provider:
obtaining, from the interbank network, a message containing a transaction identifier (ID) identifying an electronic transfer (e-transfer) transaction request initiated to transfer the amount of funds from the account at the financial institution to the e-wallet, the message also containing a security question associated with the e-transfer request, the e-transfer transaction request also having associated thereto a security response to the security question;
obtaining an e-wallet ID identifying the e-wallet, in accordance with the security question;
providing, to the interbank network, the transaction ID;
in response to the interbank network having received the transaction ID, obtaining, from the interbank network, a hash salt of the security question;
providing, to the interbank network, the hash salt of the security question, the security answer and the e-wallet ID to cause the interbank network to authenticate the transaction and to transfer the amount of funds from the account at the financial institution to the e-wallet provider; and
in accordance with the e-wallet ID and in accordance with the amount of funds, updating an e-wallet balance of the e-wallet.

12. The method of claim 11, wherein providing, to the interbank network, the transaction ID is preceded by parsing the message to extract therefrom the transaction ID.

13. A method to transfer an amount of funds from an account at a financial institution account to an electronic wallet (e-wallet), the account and the e-wallet belonging to a same user, the e-wallet being provided by an e-wallet provider, the financial institution and the e-wallet provider being coupled to an interbank network, the method comprising:
at the e-wallet provider:
obtaining, from the interbank network, a message containing a name of an individual transferring the amount funds from the account at the financial institution account to the e-wallet, the message also containing a transaction identifier (ID) identifying an electronic transfer (e-transfer) transaction request to transfer the amount of funds from the account at the financial institution to the e-wallet, the e-transfer transaction request having associated thereto a security question and a security answer to the security question, the security question and the security answer to the security question being known to the e-wallet provider;
in accordance with the name of the individual, obtaining an e-wallet account ID associated with the e-wallet account;
providing, to the interbank network, the transaction ID;
in response to the interbank network having received the transaction ID, obtaining, from the interbank network, a hash salt of the security question;
providing, to the interbank network, the hash salt of the security question, the security answer and the e-wallet ID to cause the interbank network to authenticate the transaction and to transfer the amount of funds from the account at the financial institution to the e-wallet provider; and
in accordance with the e-wallet ID and in accordance with the amount of funds, updating an e-wallet balance of the e-wallet.

14. The method of claim 8, wherein the e-wallet provider is coupled to a data store having stored thereat a plurality of names each associated with a respective e-wallet account ID, the method further comprising, at the e-wallet provider:
parsing the message to extract therefrom the name; and
obtaining, from the data store, the e-wallet account ID associated with the name.
